(19) United States
(12) Patent Application Publication
(10) Pub. No.: US 2006/0275589 A1
(43) Pub. Date: Dec. 7, 2006

(54) Film and process

(76) Inventors: David Paul Hollingbery, Palatine, IL (US); David Thomas Pollinghorne, Barrington, IL (US)

Correspondence Address: Patrick J. Halloran, Ph.D., J.D., 3141 Muirfield Road, Center Valley, PA, 18034, US

(21) Appl. No.: 11/437,262

(22) Filed: May 19, 2006

Related U.S. Application Data
(60) Provisional application No. 60/682,993, filed on May 20, 2005.

(51) Int. Cl. B41M 5/00

(52) U.S. Cl. 428/195.1

(57) ABSTRACT

This invention relates to films and methods for processing films to provide improved clarity.

### RELATED APPLICATIONS

This application claims priority to U.S. Ser. No. 60/682,993 filed May 20, 2005.

### FIELD OF THE INVENTION

This invention relates to films and methods for processing films to provide improved clarity.

### INTRODUCTION

Laminating films are commonly used to laminate numerous items from identity cards to menus to book covers. The state of the art in producing laminating films is to extrude a layer of polyethylene (PE)/ethylene vinyl acetate (EVA) onto a layer of standard polyester (PET). Current films typically have a frosted PE/EVA layer, this reduces friction but scatters light. There is a need in the art for a laminating film having reduced improved clarity as compared to currently available films.

### SUMMARY OF THE INVENTION

The present invention provides a laminating film comprising at least one surface coated or printed with a varnish such that the film has at least one optically flat surface. It is preferred that this provides the laminating film with a clear finish.

### BRIEF DESCRIPTION OF THE DRAWINGS

FIG. 1. Illustration of film preparation process.

FIG. 2. Illustration showing the impact of the processes upon the films cross section.

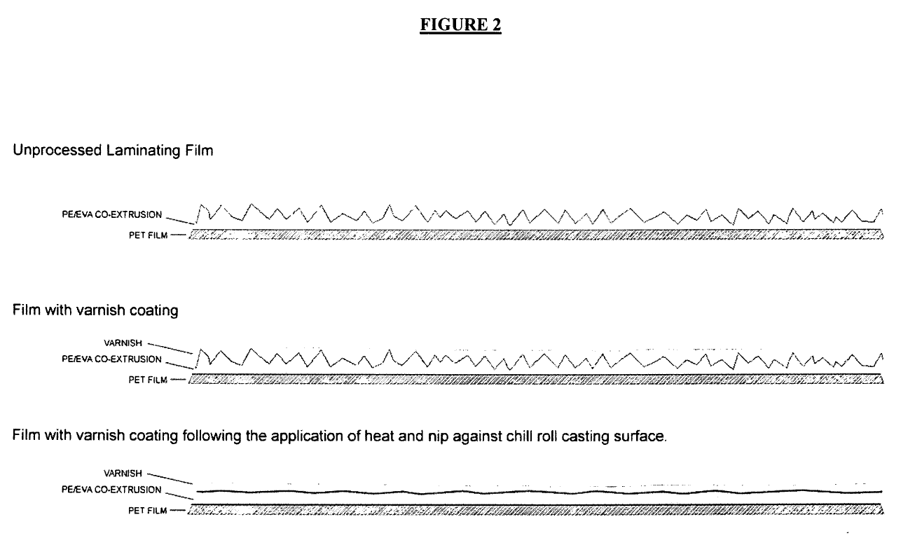

### DETAILED DESCRIPTION

The present invention provides a laminating film comprising a film having at least one surface coated or printed with a material that provides an optically flat surface. Many stock films feature numerous peaks and troughs in their surfaces, which provide a “frosted-finish” appearance. In order to reduce the opacity (or “light scattering”) of the film, the present invention provides reagents and methods for filling such peaks and troughs, thus providing a level and more transparent surface.

In one embodiment, the film comprises a layer of polyethylene terephthalate (PET), with a co-extruded blended layer of polyethylene (PE) and ethylene vinyl acetate (EVA) copolymers. PET, PE and EVA may be utilized in many different ratios including but not limited to PET to PE/EVA ratios of 1:3 or 1:5. Many suitable PET, PE and EVA copolymers are available to one of skill in the art for the purposes of practicing the present invention.

In one embodiment, a varnish is coated or printed onto stock film such that the varnish-treated film has reduced opacity over that of the standard stock film. Thus, the present invention provides a stock film having printed or coated thereon a varnish which, when complimented by the application of heat, results in the formation of an optically flat surface on the film, such that the varnish-treated film appears clear or translucent to the naked eye. This clear finish remains upon cooling of the varnish-treated film. In addition to the optical advantages of the varnish-treated film are excellent heat seal capabilities. Thus, the laminated film is capable of binding to a wide variety of plastics and many grades of paper board.

While many suitable varnishes are available to one of skill in the art, it is preferred that the varnish used to coat the film is water-based, such as an overprint flexographic varnish. In addition, while the varnish be present on the film in a wide variety of thicknesses, it is preferred that the varnish be coated or printed onto the film to a thickness of about 3 to 30 microns. Suitable ranges include, but are not limited to, 3-5 microns, 5-7 microns, 7-9 microns, 10-12 microns, 13-15 microns, 16-18 microns, 19-21 microns, 22-24 microns, 25-27 microns, or 28-30 microns.

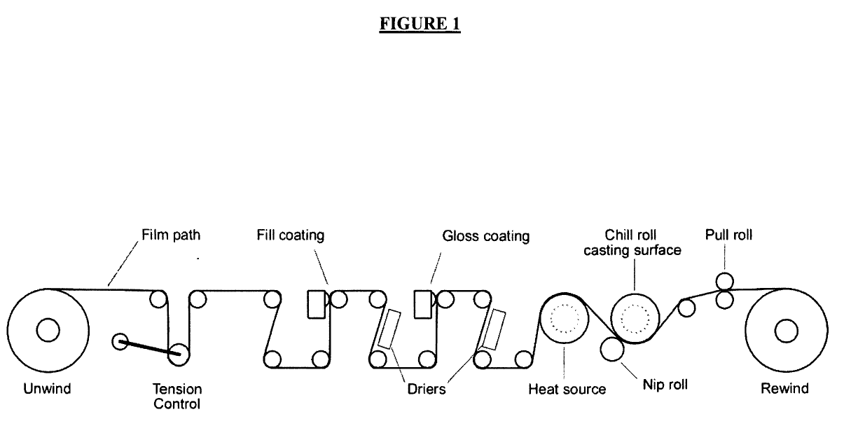

The coating, whether a varnish or another type of coating, may be applied to the film using a number of methods, including but not limited to printing onto the film surface using a tint roller (see, for example, FIG. 1). It is also possible to heat the PE/EVA surface to its melt point. It is preferred that the coated film be heated to between about 190 degrees Celsius and about 373 degrees Celsius. This causes the material to flow, again providing a level and more transparent surface. However, the use of this process alone leaves a very tacky surface with a high coefficient of friction. A combination of both “heat clearing” and the application of the water based varnish seem to produce the best results. A high level of clarity coupled with a low coefficient of friction.

A better understanding of the present invention and of its many advantages will be had from the following examples, given by way of illustration.

### EXAMPLES

The starting material is a roll of PET/PE/EVA laminating film. The PE/EVA side was coated with a varnish, which served to partially fill the troughs in the PE/EVA. This varnish coated film then passed through a drier. A second layer of varnish was then applied to the coated film to further smooth the surface of the film. After passing through a second drier the film passed over a heat source to heat the film to between about 190 degrees Celsius and about 373 degrees Celsius. The film was heated above the melting point of the PE/EVA mixture causing it to melt/flow beneath the varnish layer. The film was then nipped on to a chill roll with a mirror finish smoothing and cooling the film prior to being wound up on the rewind roll.

While the present invention has been described in terms of the preferred embodiments, it is understood that variations and modifications will occur to those skilled in the art. Therefore, it is intended that the appended claims cover all such equivalent variations that come within the scope of the invention as claimed.

What is claimed is:

1. A laminating film comprising a film having at least one surface coated or printed with a varnish.

2. The laminating film of claim 1 wherein the film comprises a mixture of polyethylene terephthalate, polyethylene, and ethylene vinyl acetate copolymers.

3. The laminating film of claim 1 or 2 wherein the varnish is water-based.

4. The laminating film of any one of claims 1-3 wherein the varnish is an overprint flexographic varnish.

5. The laminating film of any one of claims 1-4 wherein the varnish is coated or printed onto the film to a thickness of about 3 to 30 microns.

6. A method for producing a laminated film comprising coating or printing a varnish onto at least one surface of a film.

7. The method of claim 6 wherein the film comprises a mixture of polyethylene terephthalate, polyethylene, and ethylene vinyl acetate copolymers.

8. The method of claim 6 or 7 wherein the varnish is water-based.

9. The method of any one of claims 6-8 wherein the varnish is an overprint flexographic varnish.

10. The method of any one of claims 6-9 wherein the varnish is coated or printed onto the film to a thickness of about 3 to 30 microns.

11. The method of any one of claims 6-10 wherein printing is performed using a tint roller.

12. The method of any one of claims 6-11 wherein the film coated or printed with varnish is exposed to a sufficient amount of heat such that the film comprises at least one optically flat surface.

13. The method of claim 12 wherein the film and varnish are heated to a temperature of less than about 373 degrees Celsius.

14. The method of claim 12 wherein the film is heated at a temperature of at least about 190 degrees Celsius.
